(19) United States
(12) Patent Application Publication
(10) Pub. No.: US 2026/0153905 A1
(43) Pub. Date: Jun. 4, 2026

(54) STRUCTURE FOR WRAPPING MOBILE PHONE, HOUSING AND PLUG BODY

(71) Applicant: SHENZHEN NEEWER TECHNOLOGY CO. LTD, Shenzhen (CN)

(72) Inventors: Renfan YAN, Shenzhen (CN); Jun WANG, Shenzhen (CN); Yan KE, Shenzhen (CN)

(73) Assignee: SHENZHEN NEEWER TECHNOLOGY CO. LTD, Shenzhen (CN)

(21) Appl. No.: 19/357,360

(22) Filed: Oct. 14, 2025

(30) Foreign Application Priority Data
Oct. 18, 2024 (CN) 202422527746.X
Oct. 18, 2024 (CN) 202422527749.3
Oct. 18, 2024 (CN) 202422533700.9

(51) Int. Cl. G06F 1/16; H04M 1/02

(52) U.S. Cl. CPC G06F 1/1679; H04M 1/0203

(57) ABSTRACT

A structure for wrapping a mobile phone includes a housing, a plug body and a connection structure. The housing is formed with an accommodating cavity for accommodating a mobile phone, the housing is provided with a notch communicating the accommodating cavity with the outside, and the notch is configured to expose the operation keys of the mobile phone. The plug body is movably provided in the notch.

### CROSS-REFERENCE TO RELATED APPLICATIONS

This application claims priority to Chinese Patent Application No. 202422527746.X, filed on Oct. 18, 2024, Chinese Patent Application No. 202422527749.3, filed on Oct. 18, 2024, Chinese Patent Application No. 202422533700.9, filed on Oct. 18, 2024, the entire contents of which are incorporated herein by reference.

### TECHNICAL FIELD

The present application relates to the technical field of electronic products, and in particular relates to a structure for wrapping a mobile phone, a housing and a plug body.

### BACKGROUND

With the continuous advancement of smartphone technology, mobile phones have become an indispensable part of people's daily lives. In order to protect mobile phones from accidental drops, scratches and other forms of damage, most users choose to use phone cases.

For smartphones with touch buttons, existing mobile phone cases are often simply designed to leave space for the touch buttons so that users can directly touch the buttons. Although this design meets basic functional needs, the openings or blank spaces on the mobile phone case disrupt the integrity of the mobile phone case and detract from the overall appearance of the phone. To address this issue, some mobile phone case designs use rubber plugs to cover the openings or blank spaces on the mobile phone case to maintain the integrity and aesthetics of the mobile phone case. However, with frequent daily use, the rubber plugs are prone to falling out and getting lost. The loss of the rubber plugs causes inconvenience to users and may even require additional purchases for replacements, increasing the user's cost of use.

### SUMMARY

The main purpose of the present application is to provide a structure for wrapping a mobile phone, aiming to reduce the risk of the plug body being lost.

To achieve the above purpose, the structure for wrapping a mobile phone proposed by the present application includes:
a housing; and
a plug body;
the housing is formed with an accommodating cavity for accommodating the mobile phone, the housing is provided with a notch communicating the accommodating cavity with an outside, the notch is configured to expose operation keys of the mobile phone;
the plug body is movably provided in the notch.

In an embodiment, the connection structure includes a connection portion and a matching portion, the connection portion is provided at the housing, the matching portion is provided at the plug body, and the connection portion and the matching portion are detachably connected.

In an embodiment, the connection portion is a first magnetic attraction portion, the matching portion is a second magnetic attraction portion, and the first magnetic attraction portion is magnetically attracted to the second magnetic attraction portion.

In an embodiment, the connection portion and the matching portion are elastically connected.

In an embodiment, two opposite side walls of the notch include a limit section and a guide section connected to each other, and the guide section is provided at a side of the limit section facing away from the accommodating cavity; and

the plug body includes a mounting portion and a guide portion, the mounting portion is clamped between the two limit sections, and the guide portion is provided between the two guide sections.

In an embodiment, from an end of the guide section close to the limit section to an end of the guide section away from the limit section, a distance between the guide sections of the two side walls gradually increases; and

from an end of the guide portion close to the mounting portion to an end of the guide portion away from the mounting portion, a cross-sectional area of the guide portion gradually increases.

In an embodiment, the connection portion is at least one positioning groove formed on a side wall of the notch, and the matching portion is at least one positioning protrusion formed on a side wall of the plug body, and the positioning protrusion is inserted in the positioning groove after the plug body is mounted into the notch.

In an embodiment, a material of the positioning protrusion is a flexible material which is elastically deformable.

In an embodiment, the connection portion includes two positioning grooves provided at opposite side walls of the notch respectively, and the matching portion includes two positioning protrusions provided at opposite side walls of the plug body respectively, and the positioning protrusion is inserted in the positioning groove correspondingly after the plug body is mounted into the notch.

In an embodiment, the housing includes a connecting section, and two ends of the connecting section are respectively connected to two side walls of the notch.

In an embodiment, the plug body is detachably connected to the notch.

The present application further provides a housing, the housing includes:
an accommodating cavity; and
a notch,
the accommodating cavity is configured to accommodate a mobile phone, and the notch communicates the accommodating cavity with an outside, and the notch is configured to expose operation keys of the mobile phone.

In an embodiment, at least a partial structure of at least one side wall of the notch is formed with a first guiding slope.

In an embodiment, the housing includes a connecting section, and two ends of the connecting section are respectively connected to two side walls of the notch.

The present application further provides a plug body, the plug body is configured to detachably block a notch of a housing, and the plug body is detachably connected to the notch.

In an embodiment, at least a partial structure of the plug body is formed with a second guiding slope.

In the technical solution of the present application, the housing is formed with an accommodating cavity for accommodating a mobile phone, which provides good protection and prevents the mobile phone from being scratched and hit in daily use. The design of the notch can reveal the operation keys of the mobile phone, ensuring that the basic operation functions of the mobile phone are not affected, and the user can conveniently perform key operations. The plug body is detachably connected to the notch. When the operation keys are not needed, the plug body can block the notch to maintain the integrity and aesthetics of the structure for wrapping the mobile phone, and can also provide protection for the operation keys and extend the service life of the operation keys. When the operation keys are needed, the plug body can be taken out, and then the plug body is connected to the housing through the cooperation of the connection portion and the matching portion, which reduces the risk of losing the plug body. The connection portion and the matching portion are detachably connected, and the plug body can be easily separated from the housing and then installed in the notch.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art, other drawings can be obtained based on the structures shown in these drawings without creative work.

FIG. 1 is a schematic structural view of a structure for wrapping a mobile phone according to an embodiment of the present application.

FIG. 2 is an exploded schematic view of the structure for wrapping the mobile phone according to an embodiment of the present application.

FIG. 3 is a partial enlarged view of point A in FIG. 2.

FIG. 4 is a schematic structural view of a plug body according to an embodiment of the present application.

FIG. 5 is a schematic structural view of the plug body according to another embodiment of the present application.

FIG. 6 is a schematic structural view of the structure for wrapping the mobile phone according to another embodiment of the present application.

FIG. 7 is a schematic structural view of the structure for wrapping the mobile phone according to yet another embodiment of the present application.

FIG. 8 is a schematic structural view of the structure for wrapping the mobile phone according to an embodiment of the present application.

FIG. 9 is a schematic structural view of the structure for wrapping the mobile phone according to an embodiment of the present application.

FIG. 10 is a schematic structural view of the structure for wrapping the mobile phone according to an embodiment of the present application.

FIG. 11 is an enlarged schematic view of portion A in the FIG. 10.

FIG. 12 is a cross-section schematic view of A-A in the FIG. 8.

FIG. 13 is a schematic structural view of the structure for wrapping the mobile phone according to an embodiment of the present application.

FIG. 14 is a schematic structural view of the structure for wrapping the mobile phone according to an embodiment of the present application.

The objectives, functional features, and advantages of the present application will be further illustrated through the embodiments with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments of the present application, all other embodiments obtained by those skilled in the art without creative work are within the scope of protection of the present application.

It should be noted that if the embodiments of the present application involve directional indications (such as up, down, left, right, front, back . . . ), the directional indications are only used to explain the relative position relationship, movement status, etc. between the components in a certain specific posture. If the specific posture changes, the directional indications will also change accordingly.

In addition, if there are descriptions involving “first”, “second”, etc. in the embodiments of the present application, the descriptions of “first”, “second”, etc. are only used for descriptive purposes and cannot be understood as indicating or implying their relative importance or implicitly indicating the number of technical features indicated. Therefore, the features limited to “first” and “second” may explicitly or implicitly include at least one of the features. In addition, if “and/or” or “and/or” appears in the full text, its meaning includes three parallel solutions. Taking “A and/or B” as an example, it includes solution A, solution B, or solutions that satisfy both A and B. In addition, the technical solutions between the various embodiments can be combined with each other, but it must be based on the ability of those skilled in the art to implement. When the combination of technical solutions is contradictory or cannot be implemented, it should be deemed that such combination of technical solutions does not exist and is not within the scope of protection required by the present application.

The present application provides a structure for wrapping a mobile phone.

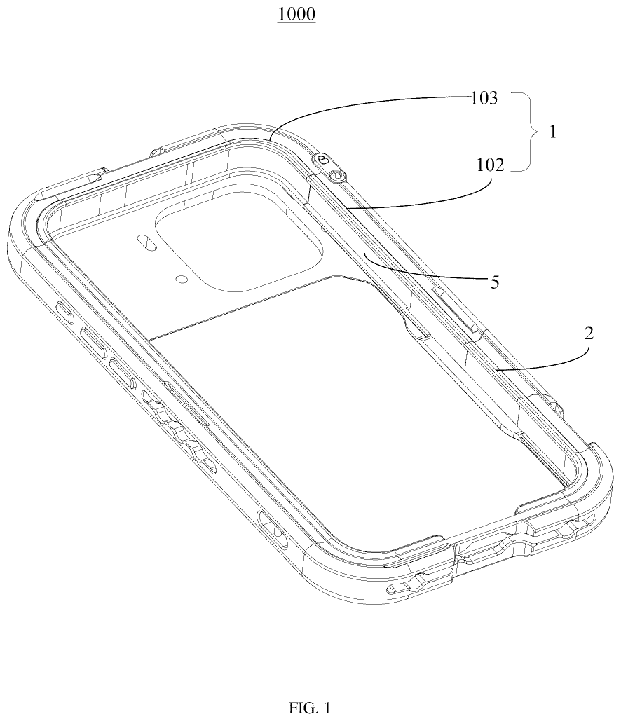

As shown in FIG. 1 to FIG. 4, in an embodiment of the present application, the structure for wrapping the mobile phone includes a housing 1 and a plug body 2; the housing 1 forms an accommodating cavity for accommodating the mobile phone, and the housing 1 is provided with a notch 101 communicating the accommodating cavity with the outside, and the notch 101 is configured to expose the operation keys of the mobile phone; the plug body 2 is movably connected to the notch 101; and the structure for wrapping the mobile phone further includes a connection structure, the connection structure includes a connection portion 3 and a matching portion 4, the connection portion 3 is provided at the housing 1, and the matching portion 4 is provided at the plug body 2, and the connection portion 3 and the matching portion 4 are detachably connected.

In an embodiment, there are many types of operation keys of the mobile phone, such as volume keys, power keys, camera control keys, etc. In the embodiment, the operation key corresponding to the notch 101 is the camera control key of the mobile phone. In an embodiment, it can also correspond to other operation keys of the mobile phone. The operation key can be a mechanical key or a touch key of a sensing type. The operation key can extend out of the notch 101 or not extend out of the notch 101. If it does not extend out of the notch 101, a person can touch the operation key of the mobile phone accommodated in the mobile phone cage through the notch 101 to operate the corresponding mobile phone function after remove the plug body 2. When the function does not need to be operated, the notch 101 can be blocked by the plug body 2 to prevent the user from touching the touch key misleadingly.

The structure for wrapping the mobile phone includes any structure installed on the periphery of the mobile phone, such as a mobile phone rig, a mobile phone case, etc. At least one of the plug body 2 and the housing 1 can be made of flexible materials such as silicone, rubber, etc., so that the structure for wrapping the mobile phone has a certain deformation ability. In an embodiment, non-flexible materials can also be selected, such as steel, iron, magnetic, hard plastic, etc. so the plug body 2 is compatible with the notch 101 and locked each other through magnetic force between the plug body 2 and the notch 101 or housing 1, or locked each other through other locking mechanisms. For example, a telescopic member or rod is provided at the side of the notch 101 or on the housing 1, and a corresponding hole is provided at the plug body 2, after the plug body 2 is located on the notch 101, the telescopic member or rod extends into the hole by the force of a spring and locks the plug body 12.

In the technical solution of the present application, the housing 1 is formed with an accommodating cavity for accommodating a mobile phone, which provides good protection and prevents the mobile phone from being scratched and hit in daily use. The design of the notch 101 can reveal the operation keys of the mobile phone, ensuring that the basic operation functions of the mobile phone are not affected, and the user can conveniently perform key operations. The plug body 2 is detachably connected to the notch 101. When the operation keys are not needed, the plug body 2 can block the notch 101 to maintain the integrity and aesthetics of the structure for wrapping the mobile phone, and can also provide protection for the operation keys and extend the service life of the operation keys. When the operation keys are needed, the plug body 2 can be taken out, The connection portion 3 and the matching portion 4 are detachably connected, and the plug body 2 can be easily separated from the housing 1 and then installed in the notch 101.

For the convenience of disassembly and assembly, in an embodiment of the present application, the connection portion 3 is the first magnetic attraction portion, the matching portion 4 is the second magnetic attraction portion, and the first magnetic attraction portion can be magnetically attracted to the second magnetic attraction portion. Through the magnetic adsorption connection between the first magnetic attraction portion and the second magnetic attraction portion, the plug body 2 and the housing 1 can be quickly disassembled and installed. When there is no need to use the operation key, the user can also easily install the plug body 2 in the notch 101 to maintain the integrity and aesthetics of the mobile phone package structure 1000. In an embodiment, at least one of the first magnetic attraction portion and the second magnetic attraction portion is a magnet, and the other is a material that can be adsorbed by a magnet. This material includes magnets with opposite polarities, and also includes metals that can be adsorbed by magnets, such as iron-containing materials.

In an embodiment of the present application, as shown in FIG. 1 to FIG. 3, the first magnetic attraction portion includes two first magnets 3a, and the two first magnets 3a are respectively provided at two opposite side walls of the notch 101. The second magnetic attraction portion includes two second magnets 4a, and the two second magnets 4a are respectively provided at both ends of the plug body 2, and each second magnet 4a can be magnetically attracted to any first magnet 3a. When the plug body 2 is provided in the notch 101, each second magnet 4a is magnetically attracted to a first magnet 3a.

It is understandable that, since each second magnet 4a can be magnetically adsorbed with any first magnet 3a, after the user takes the plug body 2 out of the notch 101, the user can achieve the connection between the plug body 2 and the housing 1 through the magnetic adsorption of any second magnet 4a and any first magnet 3a. That is, the user has multiple options to achieve the connection between the plug body 2 and the housing 1, which is convenient for use. At the same time, the two first magnets 3a are respectively provided at the two opposite side walls of the notch 101, and the two second magnets 4a are respectively provided at the two ends of the plug body 2. When the plug body 2 is pressed into the notch 101 of the housing 1, the adsorption force between the first magnet 3a and the second magnet 4a will guide the plug body 2 to be correctly installed in place, which is convenient for the user to install. After the installation is completed, the adsorption force between the first magnet 3a and the second magnet 4a also allows the plug body 2 to be stably installed in the notch 101, and the plug body 2 is not easy to fall off even in the case of movement or collision. The quantity of the first magnet 3a and the second magnet 4a can also be set to three, four, etc., and the quantity of the first magnet 3a and the second magnet 4a can be different. For example, three first magnets 3a can be set, and two first magnets 3a are respectively provided at the two opposite side walls of the notch 101, and the other first magnet 3a is provided at the outer wall of the housing 1, while two second magnets 4a are provided, respectively provided at the two ends of the plug body 2. After the plug body 2 is taken out of the notch 101, the connection between the plug body 2 and the housing 1 can be achieved by magnetic adsorption of any second magnet 4a and any first magnet 3a.

One of the connection portion 3 and the matching portion 4 is a positioning groove, and the other is a positioning protrusion, and the positioning protrusion is elastically snapped into the positioning groove. That is, the housing 1 may be provided with a positioning protrusion, and the plug body 2 may be provided with a positioning groove, or the housing 1 may be provided with a positioning groove, and the plug body 2 may be provided with a positioning protrusion. In the embodiment, the housing 1 is provided with a positioning groove 121, and the plug body 2 is provided with a positioning protrusion 4a, the positioning protrusion 4a is made of elastic materials such as rubber, silicone soft metal sheet, etc. During the insertion of the positioning protrusion into the positioning groove, the positioning protrusion 4a will be elastically deformed and fixed in the positioning groove 121, so that after the plug body 2 is mounted into the notch 101, it can be fixed at the housing 1 through the cooperation of the positioning groove 121 and the positioning protrusion 4a, thereby avoiding the loss of the plug body 2. In an embodiment, at least a part of the plug body 2 is an elastic material (connection portion 3), and the side wall of the notch 101 serves as the matching portion 4 that cooperates with the elastic material. When the plug body 2 is inserted into the notch 101, the plug body 2 is elastically deformed and inserted into the notch 101. The position of the positioning groove can be set on a side wall of the notch 101, or on the outer side wall of the housing 1. In an embodiment, the side wall material around the notch 101 can be made of elastic material, and the plug body can also be made of elastic material or hard material. In an embodiment, the connection portion and the matching portion can also be fixed by Velcro or by buckles.

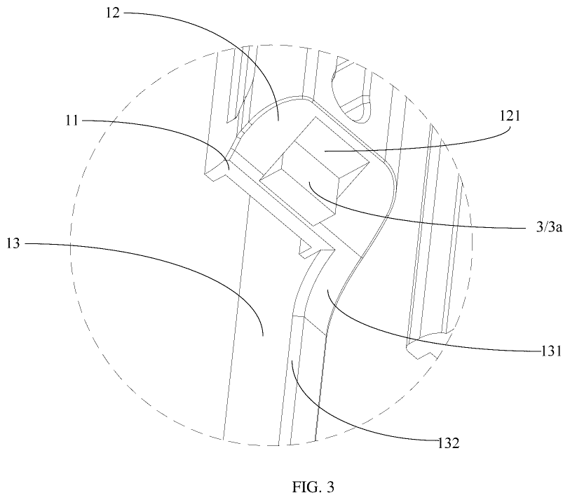

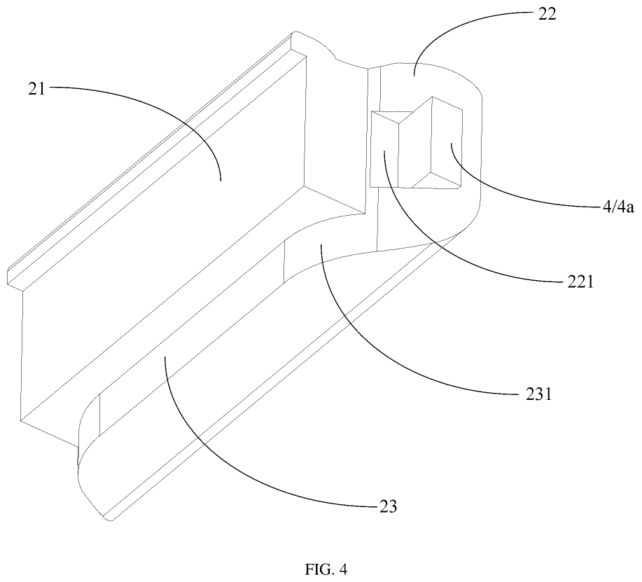

In an embodiment, as shown in FIG. 3 and FIG. 4,the connection portion is at least one positioning groove 121 formed on the side wall of the notch 101, and the matching portion is at least one positioning protrusion 4a formed on the side wall of the plug body 2, The positioning protrusion 4a is inserted in the positioning groove 121 after the plug body 2 is mounted into the notch 101. In an embodiment, the material of the positioning protrusion 4a is a flexible material which is elastically deformable, such as silicone, rubber. In an embodiment, the connection portion are two positioning grooves 121 provided at two opposite side walls of the notch 101, and the matching portion are two positioning protrusions 4a provided at opposite side walls of the plug body 2 respectively. When the plug body 2 is mounted on the notch 101, the two positioning protrusions 4a touch the two side walls of the notch and undergo slight elastic deform. After the plug body 2 is inserted in the notch 101, the two deforming positioning protrusions 4a return to their original shape and insert into the two positioning grooves 121 accordingly.

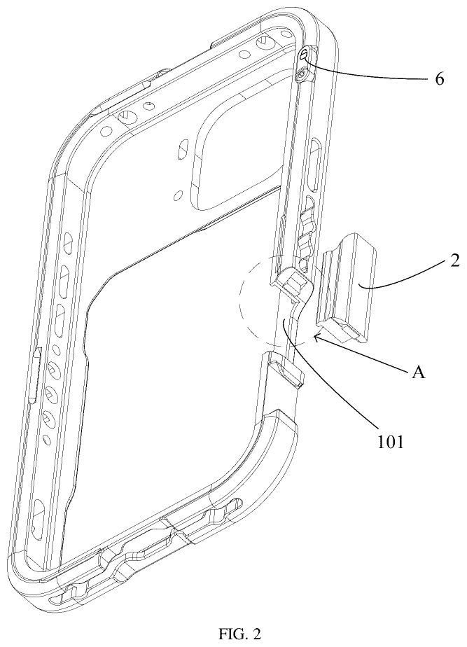

In order to facilitate the installation of the plug body 2, in an embodiment of the present application, as shown in FIG. 2 to FIG. 4, the two opposite side walls of the notch 101 include a limit section 11 and a guide section 12 connected to each other, and the guide section 12 is provided at the side of the limit section 11 facing away from the accommodating cavity; and the plug body 2 includes a mounting portion 21 and a guide portion 22, the mounting portion 21 is clamped between the two limit sections 11, and the guide portion 22 is provided between the two guide sections 12. The design of the limit section 11 and the guide section 12 provides additional positioning and alignment functions to ensure that the plug body 2 can be accurately positioned during the installation process. The design of the guide portion 22 and the guide section 12 can avoid displacement or misalignment of the plug body 2 during installation, so that the plug body 2 and the notch 101 can be perfectly matched to maintain the integrity and aesthetics of the structure for wrapping the mobile phone. In an embodiment, the distance between the two limit sections 11 is slightly smaller than the length of the mounting portion 21, so that after the mounting portion 21 is installed in place, the two ends of the mounting portion 21 will be deformed slightly and tightly fitted with the two limit sections 11 respectively, so that the plug body 2 is not easy to fall off even in the case of movement or collision, thereby improving the stability of the connection between the plug body 2 and the housing 1.

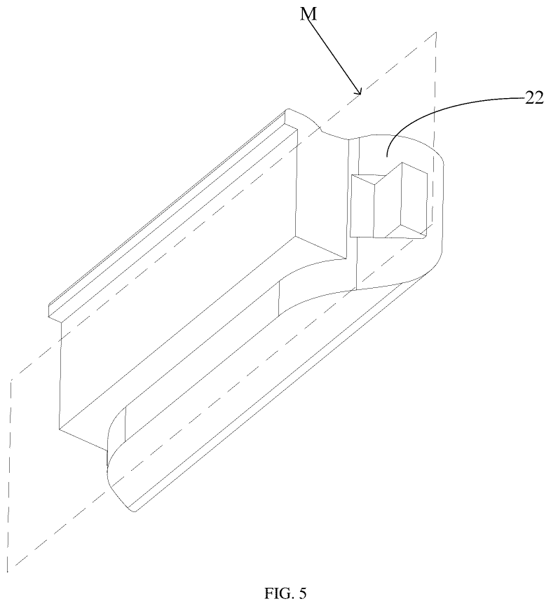

In an embodiment of the present application, as shown in FIG. 3, FIG. 4 and FIG. 5, from the end of the guide section 12 close to the limit section 11 to the end of the guide section 12 away from the limit section 11, the distance between the two guide sections 12 gradually increases From the end of the guide portion 22 close to the mounting portion 21 to the end of the guide portion 22 away from the mounting portion 21, the cross-sectional area of the guide portion 22 gradually increases. The dotted line frame indicated by M in FIG. 5 is the cross-sectional position of the guide portion 22. The design of the guide section 12 provides a progressive guide for the installation of the plug body 2. During the installation process, the path of the mounting portion 21 changes from wide to narrow, and finally clamps between the two limit sections 11. At the same time, the contact area between the two ends of the guide portion 22 and the two guide sections 12 also gradually increases, so as to achieve smooth and accurate assembly.

Further, in an embodiment of the present application, as shown in FIG. 3 and FIG. 4, each guide section 12 is formed with a first receiving groove 121, and the two ends of the guide portion 22 are respectively formed with a second receiving groove 221. The connection portion 3 includes two first magnets 3a, each of which is provided in the first receiving groove 121. The matching portion 4 includes two second magnets 4a, each of which is provided in the second receiving groove 221, and each second magnet 4a can be magnetically attracted to any first magnet 3a. When the mounting portion 21 is clamped between the two limit sections 11, each second magnet 4a is magnetically attracted to a first magnet 3a.

By setting the first magnet 3a in the first receiving groove 121 of the guide section 12 and the second magnet 4a in the second receiving groove 221 of the guide portion 22, it can be ensured that the positions of the first magnet 3a and the second magnet 4a correspond precisely. The opening size of the first receiving groove 121 and the second receiving groove 221 is sufficient to accommodate a magnet and a part of another magnet, so as to maximize the contact area between the first magnet 3a and the second magnet 4a and enhance the magnetic adsorption force. In addition, the design of the first receiving groove 121 and the second receiving groove 221 prevents the first magnet 3a and the second magnet 4a from being exposed after the plug body 2 is installed, thereby ensuring the neat appearance of the structure for wrapping the mobile phone 1000.

Furthermore, in an embodiment of the present application, as shown in FIG. 3 and FIG. 4, the housing 1 includes a connecting section 13, and the two ends of the connecting section 13 are respectively connected to a guide section 12 or a limit section 11. The plug body 2 also includes a positioning portion 23, and the positioning portion 23 is provided at the guide portion 22, and the positioning portion 23 is abutted against the connecting section 13 to limit the position. The two ends of the connecting section 13 are respectively connected to the two guide sections 12 or limit sections 11 to form an integral structure, which ensures the integrity and stability of the housing 1. The setting of the positioning portion 23 enables the plug body 2 to abut against the connecting section 13 during installation, thereby ensuring the assembly accuracy of the plug body 2.

In order to improve the assembly experience, in an embodiment of the present application, as shown in FIG. 3 and FIG. 4, a first arc segment 131 is respectively provided at both ends of the connecting section 13, and each first arc segment 131 is connected to a guide section 12 or a limit section 11; a second arc segment 231 is respectively provided at both ends of the positioning portion 23, and each second arc segment 231 is abutted against a first arc segment 131 for limiting. The first arc segment 131 and the second arc segment 231 can smoothly transition, reducing friction and resistance, so that the plug body 2 can move smoothly in the notch 101 during installation. The design of the arc segment helps to reduce the possibility of friction or impact in daily use, and improves the durability of the plug body 2 and the housing 1.

Further, in an embodiment of the present application, as shown in FIG. 3, a guide surface 132 is formed on the side of the connecting section 13 facing away from the accommodating cavity, and the guide surface 132 is provided corresponding to the mounting portion 21. During the installation of the plug body 2, if the mounting portion 21 is relatively higher than the limit section 11, the mounting portion 21 can be returned to the correct position by pressing. If the mounting portion 21 is relatively lower than the limit section 11, the mounting portion 21 can slide between the two limit sections 11 under the action of the guide surface 132, thereby improving the accuracy of assembly.

In order to improve the dustproof performance, in an embodiment of the present application, as shown in FIG. 1, the housing 1 is provided with a plurality of through holes communicating the accommodating cavity with the outside world. The structure for wrapping the mobile phone 1000 also includes a dustproof layer 5, which is provided in the accommodating cavity, and the dustproof layer 5 shields the plurality of through holes. The plurality of through holes are used to expose some function keys of the mobile phone, such as the power key, the volume key, etc. Even if the mobile phone is put in the structure for wrapping the mobile phone 1000, during long-term use, dust from the outside world will enter the structure for wrapping the mobile phone 1000 through these through holes. By setting the dustproof layer 5, these through holes can be shielded. At the same time, the dustproof layer 5 can be provided with a plurality of convex parts, and the plurality of convex parts are provided corresponding to the function keys that the mobile phone needs to press. The plurality of convex parts will pass through the corresponding through holes and be exposed outside the housing 1, so that when necessary, the corresponding function key can be pressed by pressing the corresponding convex part. In addition, it should be noted that the dustproof layer 5 does not cover all through holes. For example, the through holes of the charging port and the speaker port will not be covered, and all other necessary through holes will not be covered. In this way, even if the mobile phone is placed in the structure for wrapping the mobile phone 1000, it will not affect the normal use of the mobile phone.

Further, in an embodiment of the present application, as shown in FIG. 1, the housing 1 includes a first frame 102 and a second frame 103, the first frame 102 and the second frame 103 are flexible. The first frame 102 includes a fixed end and a movable end, the fixed end is flexibly connected to the second frame 103, so that the movable end can be close to or away from the second frame 103, the first frame 102 and the second frame 103 are enclosed to form an accommodating cavity for accommodating a mobile phone, and the structure for wrapping the mobile phone 1000 also includes a locking member 6, one end of the locking member 6 is connected to the second frame 103 through a screw, and the other end of the locking member 6 is formed with a protrusion, and the movable end is formed with a groove, and the protrusion can connect the first frame 102 and the second frame 103 when inserted into the groove. When the mobile phone needs to be placed in the structure for wrapping the mobile phone 1000, the protrusion needs to be pulled out of the groove first, and then the movable end is moved away from the second frame 103. At this time, the mobile phone can be conveniently placed in the second frame 103, and then the movable end is brought close to the second frame 103, and the protrusion is inserted into the groove to complete the installation of the mobile phone. This process does not require the mobile phone to be forced into the structure for wrapping the mobile phone 1000, thereby avoiding wear and tear on the mobile phone or the structure for wrapping the mobile phone 1000 during the installation process.

The present application further provides a housing 1, the housing 1 includes an accommodating cavity and a notch 101, the accommodating cavity is configured to accommodate a mobile phone, and the notch 101 communicates the accommodating cavity with the outside, and the notch 101 is configured to expose the operation keys of the mobile phone.

Please refer to all the above embodiments for the specific structure of the housing 1. The housing 1 in the embodiment can adopt all the technical features of the housing 1 in the above embodiments and can have all the structures of the housing 1 in the above embodiments, which will not be described one by one here. By movably setting the plug body 2 in the notch 101, when the operation key is not needed, the plug body 2 can be installed in the notch 101 to maintain the integrity and aesthetics of the structure for wrapping the mobile phone. When the operation key is needed, the plug body 2 can be taken out.

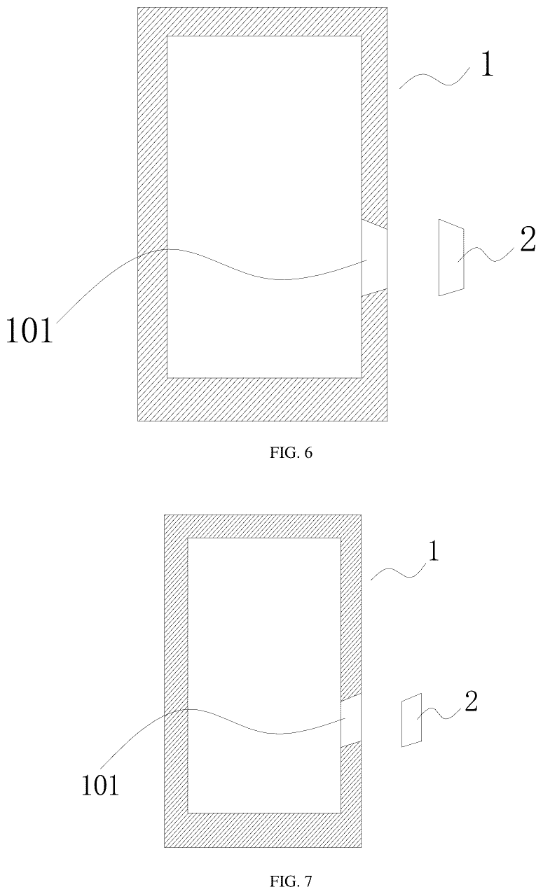

Further, at least a partial structure of at least one side wall of the notch 101 is formed with a first guiding slope. In an embodiment of the present application, the specific setting of the first guiding slope can be the guide section 12 of the housing 1 in the above embodiment, that is, the partial structure of the two side walls of the notch 101 is formed with first guiding slopes. The setting of the first guiding slope can play a guiding role when the plug body 2 is installed in the notch 101, which is convenient for rapid alignment, so that the plug body 2 can be quickly inserted into the notch 101. In an embodiment, it can also be that a partial structure of a side wall of the notch 101 is formed with a first guiding slope, or a side wall of the notch 101 is inclined to form a first guiding slope, as long as it can play a guiding role. The first guiding slope can be an inclined plane, or an inclined curved surface or a combination thereof. In an embodiment, the inclination direction of at least one inclined surface of the notch can also be opposite to the direction in FIG. 5, and the corresponding inclined part of the notch 101 is also set to a side surface that cooperates with the reverse inclined surface. The notch 101 with the inclined surface in the embodiment can limit the plug body 2 from falling, and the plug body 2 can enter the notch by elastic deformation when it is inserted into the notch 101, as shown in FIG. 6 and FIG. 7. The inclined surface can not only play a guiding and alignment role, but also a limiting role.

The present application further provides a plug body 2, which is configured to detachably block the notch 101 of the housing 1, and the plug body 2 is detachably connected to the notch 101.

Please refer to all the above embodiments for the specific structure of the plug body 2. The plug body 2 in the embodiment can adopt all the technical features of the plug body 2 in the above embodiments and can have all the structures of the plug body 2 in the above embodiments, which will not be described one by one here. By movably setting the plug body 2 in the notch 101, when the operation key is not needed, the plug body 2 can block the notch 101 to maintain the integrity and aesthetics of the structure for wrapping the mobile phone 1000. When the operation key is needed, the plug body 2 can be taken out, and then the plug body 2 is connected to the housing 1 through the cooperation of the connection portion 3 and the matching portion 4, thereby reducing the risk of losing the plug body 2.

Further, at least a partial structure of the plug body 2 is formed with a second guiding slope. The second guiding slope cooperates with the first guiding slope of the notch 101 for guidance, and plays a guiding role when the plug body 2 is installed in the notch 101, which is convenient for quick alignment, so that the plug body 2 can be quickly inserted into the notch 101. In the embodiment, the specific setting of the second guiding slope can refer to the guide portion 22 of the plug body 2 in the above-mentioned embodiment, so as to cooperate with the guide section 12 of the housing 1 for guidance. In an embodiment, the specific setting of the second guiding slope is set according to the actual situation of the first guiding slope, so as to facilitate the guidance.

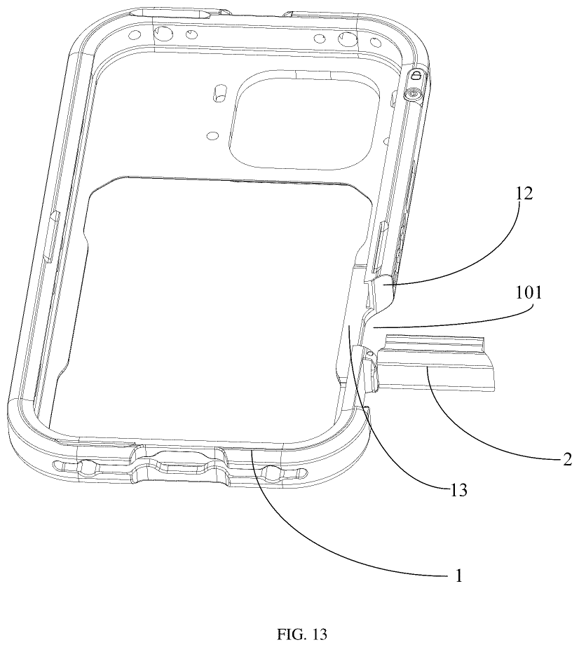

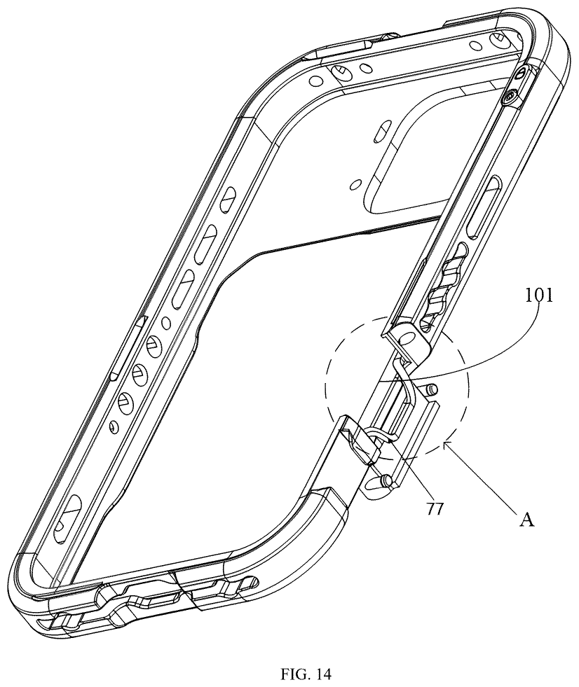

In an embodiment, as shown in FIG. 14, a connection structure 77 (such as a rope or a chain) may be further included, with at least one end of the connection structure 77 connected to the plug body and the other end of the connection structure connected to the housing, so as to prevent the plug body from being separated from the housing and missing when being taken out of the notch. In an embodiment, according to FIG. 13, the material of the connection structure 77 is silicone or rubber, two ends of the connection structure 77 connect to two ends of the plug body 2 correspondingly.

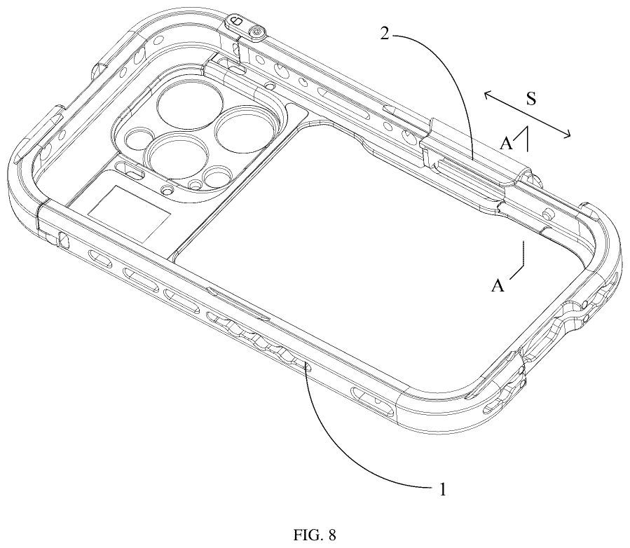

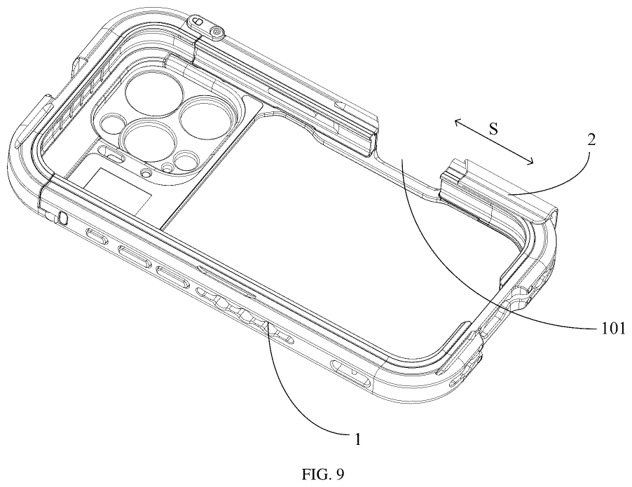

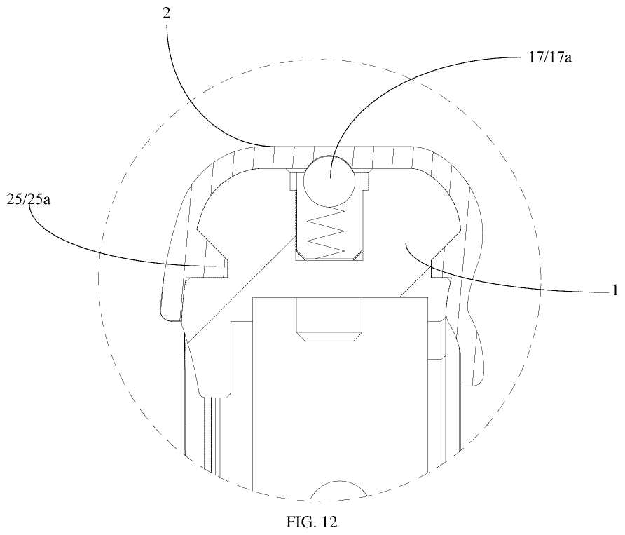

In an embodiment, as shown in FIG. 8 to FIG. 12, a sliding portion 25a is formed on the plug body 25, and a second matching portion 16a is formed on the housing 1, the sliding portion 25a is sliding provided at the second matching portion 16a, so the plug body 2 may slide to the location covering or revealing the notch 101, and the direction S is the sliding orientation of the plug body 2.

In an embodiment, the sliding motion between the sliding portion 25a and the second matching portion 16a may be achieved by either a sliding boss 25a and sliding slot 16a, or by a pulley and sliding slot 16a. For example, the sliding portion 25a can be two sliding boss 25a provided at the opposite sides of the plug body 2. The second matching portion 16a are two sliding slot 16a provided at the housing 1, and each sliding boss 25a slides within the sliding slot 16a. Since the two sliding boss 25a is provided at opposite sides of the plug body 25a. When the sliding boss 25a is provided at the sliding slot 16a, the plug body 2 clamps the housing 1, so the plug body 2 is capable of sliding smoothly and stably on the housing 1.

Further, in an embodiment, as shown in FIG. 8 to FIG. 12, a telescopic member 17 is provided at the housing 1. A hole is provided at the plug body 2, and the hole is used to match with the telescopic member 17. When the plug body 2 slides to the position where the notch 101 is covered by the plug body 2, the telescopic member 17 extends into the hole to match with the hole. The matching of the hole and the telescopic member 17 lock the plug body 2. In an embodiment, the telescopic member 17 is a positioning ball 17a, and the housing 1 further includes a spring or other elastic element, the spring is used to push and force at least a portion of the positioning ball 17a to extend. When the plug body 2 slides to a position covering the notch 101, the positioning ball 17a extends and inserts into the hole on the plug body 2. When the plug body 2 slides to a position revealing the notch 101, the positioning ball 17a is retracted pushed by the plug body 2 and leaves the hole. In an embodiment, the sliding connection between the plug body 2 and the housing 1 is damping sliding connection, so when the plug body 2 slides to the position covering the notch 101, because of the damping connection, the plug body 2 is locked and can not slide backward.

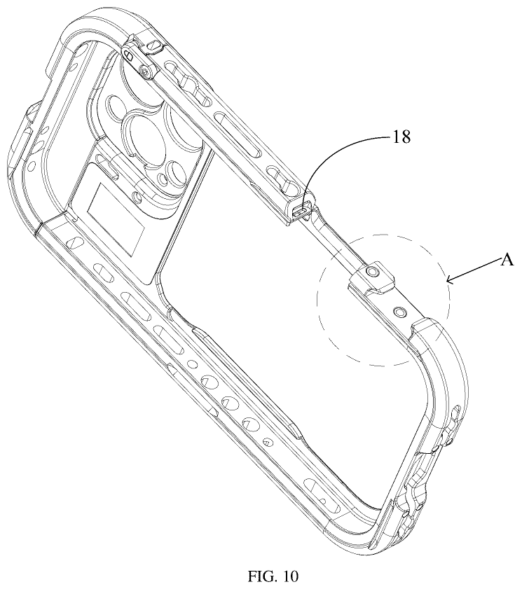

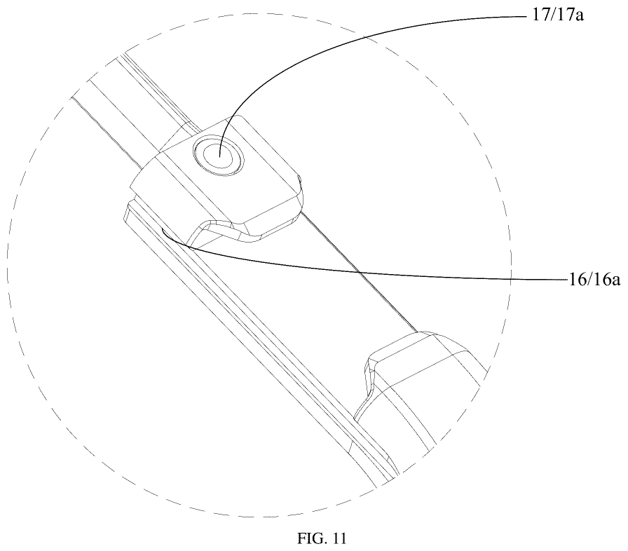

In an embodiment, as shown in FIG. 10, a receiving hole 18 is provided at the side wall of the notch 101, and the plug body 2 can be retracted and installed in the receiving hole 18. When the notch 101 needs to be covered, the plug body 2 extends from the receiving hole 18 and blocks the notch 101. When the notch 101 needs to be revealed, the plug body 2 retracts into the receiving hole 18. The plug body 2 can be connected to an operation key, and the user can use the operation key to operate the plug body 2 to extend or retract. For example, an operation key can be set on the plug body 2 and the end exposed in the notch 101. The user can push the operation key along the S direction to push the plug body 2 to extend or retract. In addition, an elastic member such as a spring can be set in the receiving hole 18. The spring can be in a compressed state and used to automatically push the plug body 2 out to cover the notch 101. The user can push the operation key to overcome the spring pressure and push the plug body 2 back to the receiving hole 18. In addition, a locking device can be provided. When the plug body 2 is pushed back to the receiving hole 18, the locking device locks the plug body 2 to prevent the plug body 2 from automatically extending. When the button or knob of the locking device is operated, the plug body 2 is released. The plug body 2 can be automatically pushed out to cover the notch 101 under the action of the spring force.

In an embodiment, as shown in FIG. 13, the plug body 2 can be rotatably mounted on the edge of the notch 101, and the plug body 2 can be rotated to open or close the notch 101. It can be understood that the design of the plug body 2 being rotatably mounted on the edge of the notch 101 or on the housing 1 in any direction and manner is an equivalent design to the embodiment.

The above description is only an exemplary embodiment of the present application, and does not limit the patent scope of the present application. All equivalent structural changes made by using the contents of the present application specification and drawings under the technical concept of the present application, or directly/indirectly applied in other related technical fields are included in the patent protection scope of the present application.

What is claimed is:

1. A structure for wrapping a mobile phone, comprising:
a housing; and
a plug body;
wherein the housing is formed with an accommodating cavity for accommodating the mobile phone, the housing is provided with a notch communicating the accommodating cavity with an outside, the notch is configured to expose operation keys of the mobile phone; and
the plug body is movably connected to the notch.

2. The structure for wrapping the mobile phone according to claim 1, further comprising:
a connection structure;
wherein the connection structure comprises a connection portion and a matching portion, the connection portion is provided at the housing, the matching portion is provided at the plug body, and the connection portion and the matching portion are detachably connected.

3. The structure for wrapping the mobile phone according to claim 2, wherein the connection portion is a first magnetic attraction portion, the matching portion is a second magnetic attraction portion, and the first magnetic attraction portion is magnetically attracted to the second magnetic attraction portion.

4. The structure for wrapping the mobile phone according to claim 2, wherein the connection portion and the matching portion are elastically connected.

5. The structure for wrapping the mobile phone according to claim 2, wherein two opposite side walls of the notch comprise a limit section and a guide section connected to each other, and the guide section is provided at a side of the limit section facing away from the accommodating cavity; and
the plug body comprises a mounting portion and a guide portion, the mounting portion is clamped between the two limit sections, and the guide portion is provided between the two guide sections.

6. The structure for wrapping the mobile phone according to claim 5, wherein from an end of the guide section close to the limit section to an end of the guide section away from the limit section, a distance between the guide sections of the two side walls gradually increases; and
from an end of the guide portion close to the mounting portion to an end of the guide portion away from the mounting portion, a cross-sectional area of the guide portion gradually increases.

7. The structure for wrapping the mobile phone according to claim 2, wherein the connection portion is at least one positioning groove formed on a side wall of the notch, the matching portion is at least one positioning protrusion formed on a side wall of the plug body, and the positioning protrusion is inserted in the positioning groove after the plug body is mounted into the notch.

8. The structure for wrapping the mobile phone according to claim 7, wherein a material of the positioning protrusion is a flexible material which is elastically deformable.

9. The structure for wrapping the mobile phone according to claim 8, wherein the connection portion comprises two positioning grooves provided at opposite side walls of the notch respectively, the matching portion comprises two positioning protrusions provided at opposite side walls of the plug body respectively, and the positioning protrusion is inserted in the positioning groove correspondingly after the plug body is mounted into the notch.

10. The structure for wrapping the mobile phone according to claim 1, wherein the housing comprises a connecting section, and two ends of the connecting section are respectively connected to two side walls of the notch.

11. The structure for wrapping the mobile phone according to claim 1, wherein the plug body is detachably connected to the notch.

12. A housing, comprising:
an accommodating cavity; and
a notch,
wherein the accommodating cavity is configured to accommodate a mobile phone, and the notch communicates the accommodating cavity with an outside, and the notch is configured to expose operation keys of the mobile phone.

13. The housing according to claim 12, wherein at least a partial structure of at least one side wall of the notch is formed with a first guiding slope.

14. The housing according to claim 12, wherein the housing comprises a connecting section, and two ends of the connecting section are respectively connected to two side walls of the notch.

15. A plug body, wherein the plug body is configured to detachably block a notch of a housing, and the plug body is detachably connected to the notch.

16. The plug body according to claim 15, wherein at least a partial structure of the plug body is formed with a second guiding slope.
